(19) United States
(12) Patent Application Publication
(10) Pub. No.: US 2025/0028170 A1
(43) Pub. Date: Jan. 23, 2025

(54) OFF-AXIS DUAL MIRROR FOCUSING BACKLIGHT DISPLAY DEVICE AND HEAD-UP DISPLAY DEVICE

(71) Applicant: E-LEAD ELECTRONIC CO., LTD., Changhua (TW)

(72) Inventor: Stephen Chen, Changhua (TW)

(21) Appl. No.: 18/484,447

(22) Filed: Oct. 11, 2023

(30) Foreign Application Priority Data
Jul. 19, 2023 (TW) 112126855

(51) Int. Cl. G02B 27/01; G02B 27/09

(52) U.S. Cl. CPC G02B 27/0101; G02B 27/0179; G02B 27/0961; G02B 27/0983; G02B 5/0278; G02B 2027/0181

(57) ABSTRACT

An off-axis dual mirror focusing backlight display device includes: a light emitting array including light sources and a backlight source; a conical light cup array including conical light cups, and set on an incoming light side of the conical light cup array, each light source corresponds to a conical light cup, and the conical light cup array magnifies the backlight source to reduce diffusion angle thereof; a diffuser on an outgoing light side of the conical light cup array to increase uniformity of the backlight source; a first curved mirror for receiving and reflecting the backlight source; a second curved mirror for receiving and reflecting the backlight source reflected by the first curved mirror; a display module for receiving the backlight source reflected by the second curved mirror; and at least one of the first curved mirror and the second curved mirror is a concave mirror.

### BACKGROUND

### Field of the Invention

The present invention relates to a backlight display device, and more particularly to an off-axis dual mirror focusing backlight display device.

The present invention further relates to a head-up display device with an off-axis dual mirror focusing backlight display device.

### Description of Related Art

Prior art such as CN102777803A and CN102812289B reveals an illumination device or system that utilizes a conical light cup (such as collimator 12 disclosed by CN102812289B). Although the conical light cup can enlarge the area of the light source and reduce the diffusion angle of the light source, in order to efficiently generate the desired or predetermined light distribution pattern in the target area, the above lighting systems using conical light cups are often used for automotive headlight lighting, studio, theater lighting, building lighting, etc.

If a conical light cup is to be applied to a backlight display device or a head up display device, it will face the problem of light diffusion angle and the technical problem of how the projected light fully covers the display module.

### SUMMARY

The present invention provides an off-axis dual mirror focusing backlight display device, which mainly aims to diffuse the light emitted the conical light cup array at different inclination angles, and fully cover the display module with the diffusion angle of the light.

The present invention also provides a head-up display device with an off-axis dual mirror focusing backlight display device, which mainly aims to arrange the position of the real image eye box formed by the backlight source inside the windshield.

To achieve the above objective, an off-axis dual mirror focusing backlight display device in accordance with the present invention comprises:
a light emitting array including a plurality of light sources, and providing a backlight source;
a conical light cup array including a plurality of conical light cups, and set on an incoming light side of the conical light cup array, wherein each of the light sources corresponds to a corresponding one of the conical light cups, and the conical light cup array is configured to magnify the backlight source to reduce diffusion angle of the backlight source;
a diffuser set on an outgoing light side of the conical light cup array, and configured to increase uniformity of the backlight source;
a first curved mirror for receiving and reflecting the backlight source;
a second curved mirror for receiving and reflecting the backlight source reflected by the first curved mirror;
a display module for receiving the backlight source reflected by the second curved mirror; and
at least one of the first curved mirror and the second curved mirror is a concave mirror.

It can be seen from the above that the invention is mainly by making the light sources located on the incoming light side of the conical light cup array, and the diffuser arranged on the outgoing light side of the conical light cup array, so that the light projected by each conical light cup can completely cover the display module.

The present invention further provides a head-up display device with the off-axis dual mirror focusing backlight display device, which further comprises:
a windshield and an imaging concave mirror, the imaging concave mirror is configured to reflect an image light source projected by the display module to the windshield, and the windshield is configured to reflect the image light source and image at a driver's eye box position.
the display module is set within the focal length of the imaging concave mirror, the equivalent distance of the backlight source is greater than the focal length of the imaging concave mirror, a virtual image formed by the display module is located outside the windshield, and the backlight source forms the driver's eye box position inside the windshield.

It can be seen from the above that the invention is mainly by making the display module set within the focal length of the imaging concave mirror, the equivalent distance of the backlight source is greater than the focal length of the imaging concave mirror, the virtual image formed by the display module is located outside the windshield, and the backlight source forms the driver's eye box position inside the windshield.

### BRIEF DESCRIPTION OF THE DRAWINGS

FIG. 1 is a schematic diagram of the conical light cup array of the invention;

FIG. 2 is an architectural diagram of the off-axis dual mirror focusing backlight display device of the invention;

FIG. 3 is a schematic diagram of another embodiment of the conical light cup array of the invention;

FIG. 4 is a schematic diagram of another embodiment of the conical light cup array of the invention;

FIG. 5 is a schematic diagram of one embodiment of the backlight source of the invention;

FIG. 6 is a schematic diagram of another embodiment of the backlight source of the invention;

FIG. 7 is a schematic diagram of another embodiment of the backlight source of the invention;

FIG. 8 shows the architecture diagram of the head-up display device;

FIG. 9 is an architectural diagram of another embodiment of the present head-up display device;

FIG. 10 is an architectural diagram of another embodiment of the present head-up display device; and

FIG. 11 is an architectural diagram of another embodiment of the present head-up display device.

### DETAILED DESCRIPTION

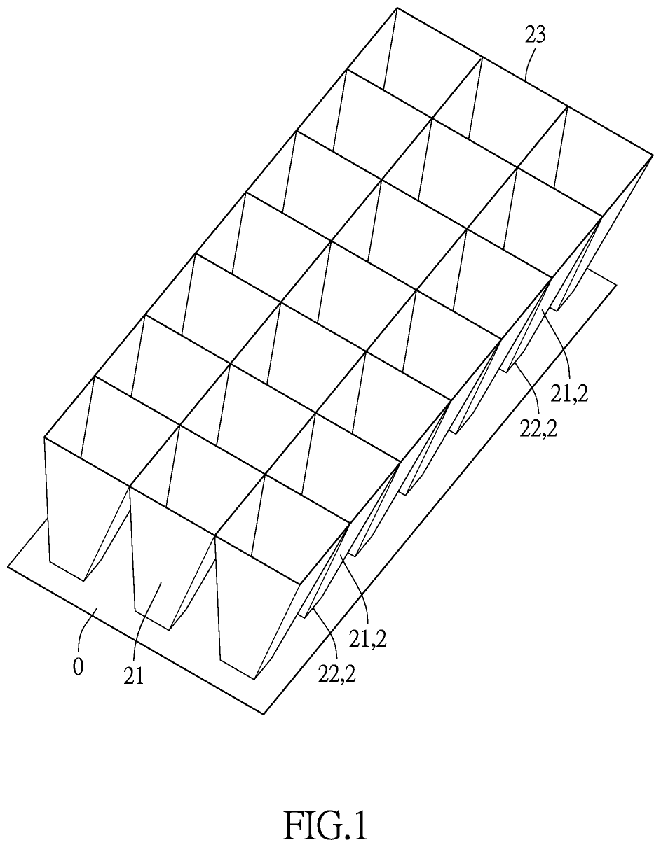

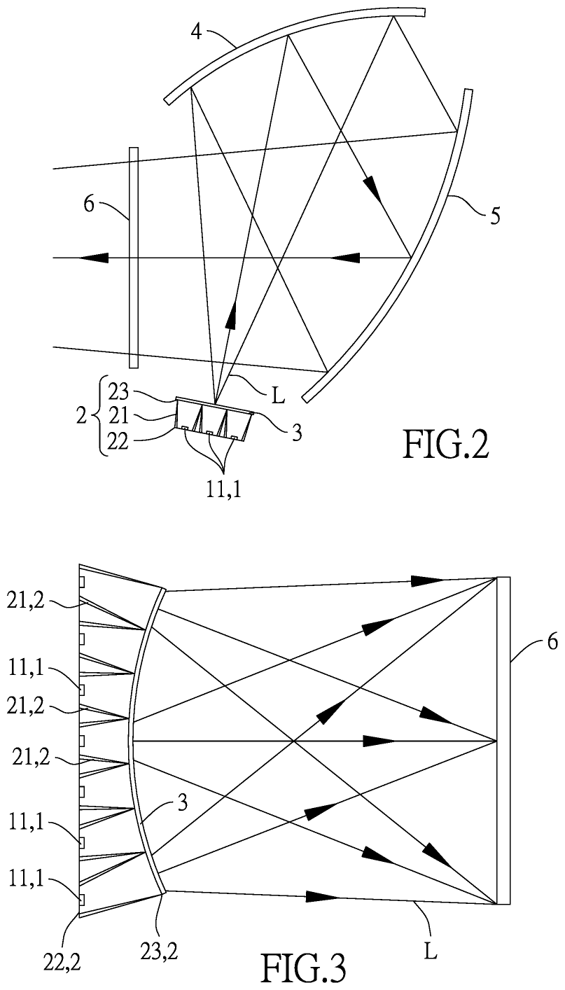

An off-axis dual mirror focusing backlight display device in accordance with an embodiment of the present invention, as shown in FIGS. 1-7, includes:

A light emitting array 1 includes a plurality of light sources 11, and provides a backlight source B. In this embodiment, the light emitting array 1 is an LED array, which is set on an aluminum substrate 0;

A conical light cup array 2 includes a plurality of conical light cups 21, and each of the light sources 11 corresponds to a corresponding one of the conical light cups 21. The conical light cups 21 are hollow light cups coated with a high reflectivity coating or transparent solid light cups, and the conical light cups 21 use the wall of the cup with a high refractive index to generate total reflection. The light emitting array 1 is set on an incoming light side 22 of the conical light cup array 2, and the conical light cup array 2 is used to magnify the backlight source B, to reduce the diffusion angle of light sources;

A diffuser 3 is set on the outgoing light side 23 of the conical light cup array 2, which is used to increase the uniformity of the backlight source B;

A first curved mirror 4, which is a free form curved mirror, is used to receive and reflect the backlight source B;

A second curved mirror 5, which is a free form curved mirror, is used to receive and reflect the backlight source B reflected by the first curved mirror 4;

A display module 6 for receiving the backlight source reflected by the second curved mirror 5. In this embodiment, the display module 6 is a TFT panel;

In this embodiment, at least one of the first curved mirror 4 and the second curved mirror 5 is a concave mirror, which is used for magnifying and pulling away the backlight source B;

Please refer to FIG. 3, the conical light cups 21 have different inclinations, and the inclinations of these conical light cups 21 gradually decrease from the two sides of the conical light cup array 2 to the center thereof. The conical light cups 21 are inclined towards the center of the conical light cup array 2, and the diffuser 3 is a curved sheet member. The light L from the opening of each of the conical light cups 21 completely covers the entire display module 6. It is worth mentioning that FIG. 3 specifically omits the first curved mirror 4 and the second curved mirror 5.

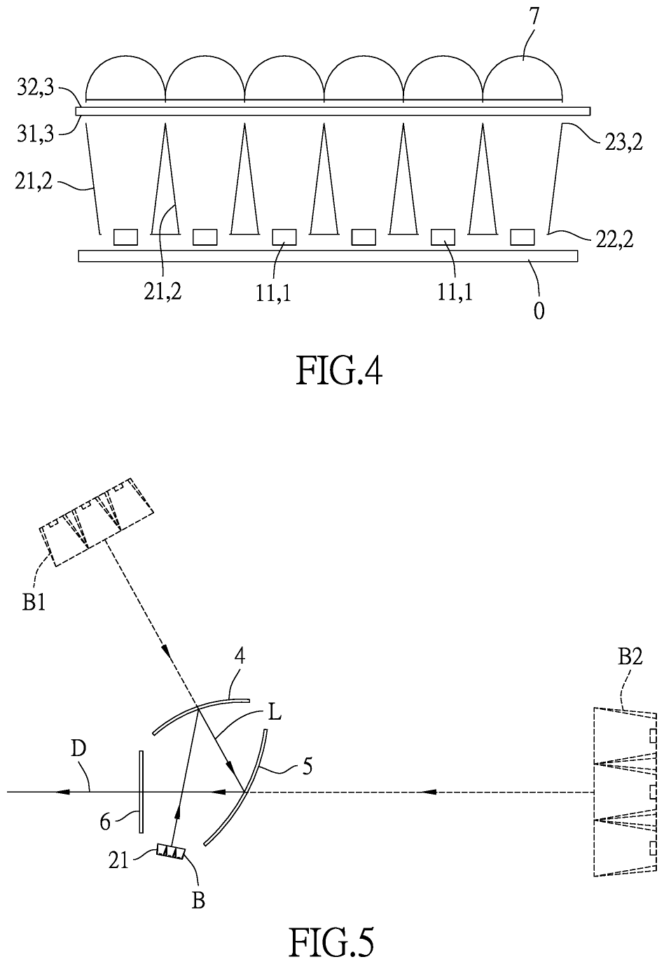

In a preferred embodiment, please refer to FIG. 4, which further includes a convex lens array 7, the diffuser 3 is a planar sheet member, the convex lens array 7 includes a plurality of convex lenses. The convex lens array 7 is arranged on an outgoing light side 32 of the diffuser 3, so that the diffuser 3 is located between the convex lens array 7 and the conical light cup array 2. The output side 23 of the conical light cup array 2 faces an incoming light side 31 of the diffuser 3. In this embodiment, by utilizing the conical opening of the conical light cups 21 to enlarge the area of the light source and reduce the diffusion angle of the light source, the conical light cups 21 can make the light source closer, and the diffuser 3 can increase the uniformity of the light, but the diffusion angle of the light will increase. Therefore, the convex lens array 7 can once again reduce the diffusion angle of the light source to the desired angle.

In a preferred embodiment, please refer to FIG. 5, where the light emitting array 1 is used as the backlight source B. The light L generated by the light emitting array 1 is projected onto the first curved mirror 4 and the second curved mirror 5 after leaving the openings of the conical light cups 21. The first curved mirror 4 is a concave mirror to magnify and pull away the backlight source B1, while the second curved mirror 5 is a concave mirror to further magnify and pull away the backlight source B2. The light ray L is reflected from the second curved mirror 5 and then passes through the display module 6 to project an image light source D onto the display module 6.

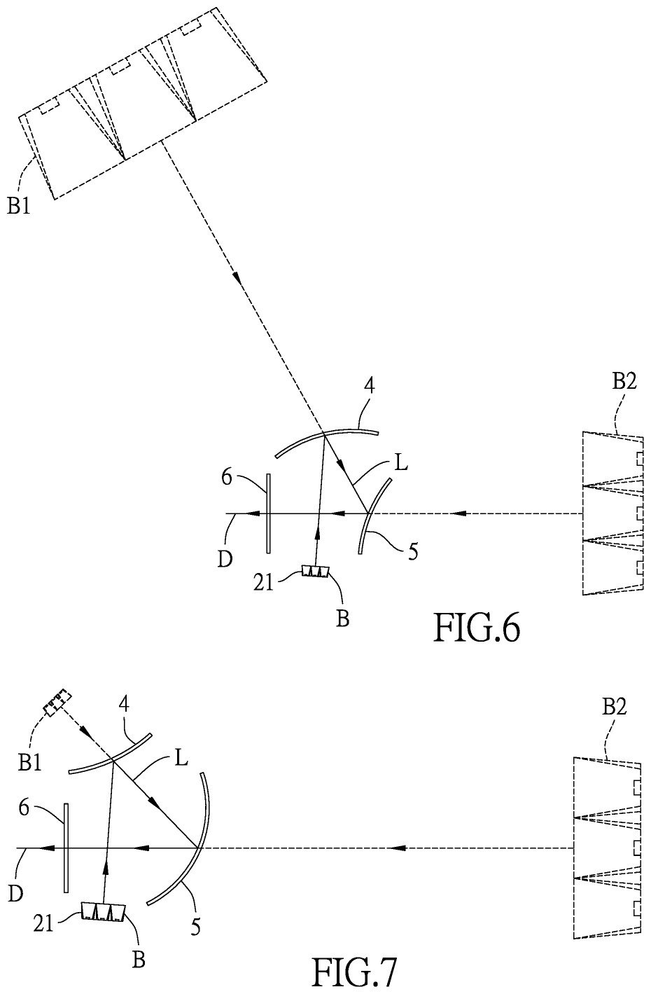

In a preferred embodiment, please refer to FIG. 6, where the light emitting array 1 is used as the backlight source B. The light L generated by the light emitting array 1 is projected onto the first curved mirror 4 and the second curved mirror 5 after leaving the openings of the conical light cups 21. The first curved mirror 4 is a concave mirror to magnify and pull away the backlight source B1, while the second curved mirror 5 is a convex mirror to reduce and bring the backlight source B2 closer. The light L is reflected from the second curved mirror 5 and then passes through the display module 6, to project the image light source D onto the display module 6.

In a preferred embodiment, please refer to FIG. 7, where the light emitting array 1 is used as the backlight source B. The light L generated by the light emitting array 1 is projected onto the first curved mirror 4 and the second curved mirror 5 after leaving the openings of the conical light cups 21. The first curved mirror 4 is a convex mirror to reduce and bring closer the backlight source B1, while the second curved mirror 5 is a concave mirror to magnify and pull away the backlight source B2. The light L is reflected from the second curved mirror 5 and then passes through the display module 6, to project the image light source D onto the display module 6.

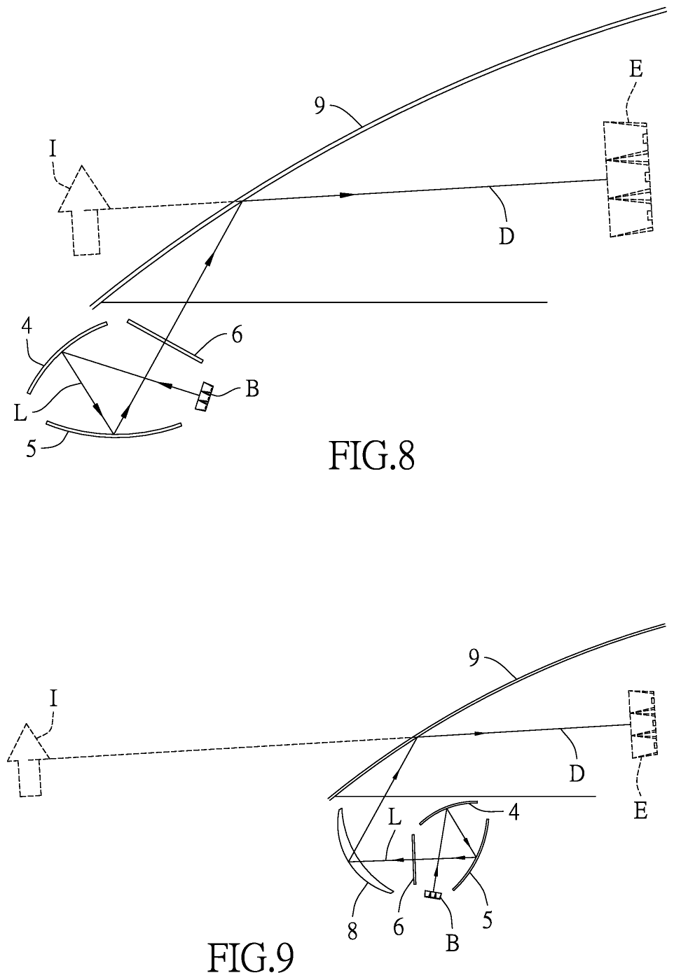

The head up display device with an off-axis dual mirror focusing backlight display device, in one embodiment of the invention, as shown in FIG. 8, further includes:

A windshield 9 is used to reflect the image light source D projected from the display module 6 and image at a driver's eye box position E. The windshield 9 is a head up display device, further, the windshield 9 reflects the image light source D of the display module 6 to form a virtual image I. The backlight source B is imaged in real image by passing through the first curved mirror 4 and the second curved mirror 5, and is imaged at the driver's eye box position E through the reflection of the windshield 9.

In another embodiment, as shown in FIG. 9, an imaging concave mirror 8 is disposed between the display module 6 and the windshield 9. The first and second curved mirrors 4 and 5 are both concave mirrors, and the imaging concave mirror 8 is used to reflect the image light source D passing through the display module 6 to the windshield 9. The windshield 9 is used to reflect the image light source D and image at the driver's eye box position E. The display module 6 is set within the focal length of the imaging concave mirror 8, and the equivalent distance of the backlight source B (please refer to FIG. 5) is greater than the focal length of the imaging concave mirror 8. The virtual image I formed by the display module 6 is located outside the windshield 9, and the backlight source B forms the driver's eye box position E inside the windshield 9.

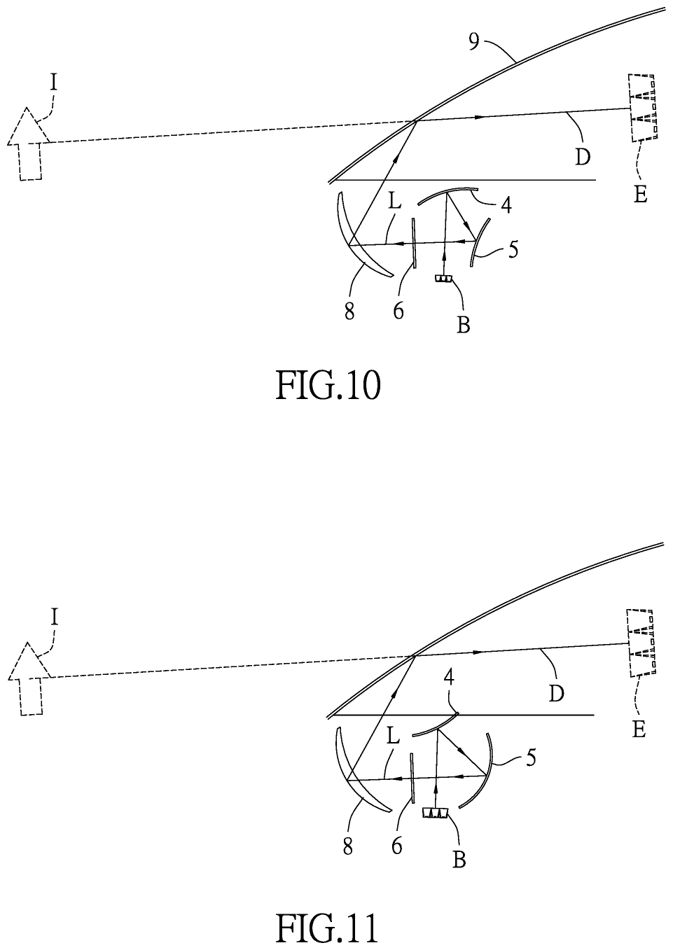

In another embodiment, as shown in FIG. 10, the imaging concave mirror 8 is disposed between the display module 6 and the windshield 9. The first curved mirror 4 is a concave mirror, the second curved mirror 5 is a convex mirror, and the imaging concave mirror 8 is used to reflect the image light source D passing through the display module 6 to the windshield 9. The windshield 9 is used to reflect the image light source D and image at the driver's eye box position E. The display module 6 is set within the focal length of the imaging concave mirror 8, and the equivalent distance of the backlight source B (please refer to FIG. 6) is greater than the focal length of the imaging concave mirror 8. The virtual image I formed by the display module 6 is located outside the windshield 9, and the backlight source B forms the driver's eye box position E inside the windshield 9.

In another embodiment, as shown in FIG. 11, the imaging concave mirror 8 is disposed between the display module 6 and the windshield 9. The first curved mirror 4 is a convex mirror, the second curved mirror 5 is a concave mirror, and the imaging concave mirror 8 is used to reflect the image light source D passing through the display module 6 to the windshield 9. The windshield 9 is used to reflect the image light source D and image at the driver's eye box position E. The display module 6 is set within the focal length of the imaging concave mirror 8, and the equivalent distance of the backlight source B (please refer to FIG. 7) is greater than the focal length of the imaging concave mirror 8. The virtual image I formed by the display module 6 is located outside the windshield 9, and the backlight source B forms the driver's eye box position E inside the windshield 9.

What is claimed is:

1. An off-axis dual mirror focusing backlight display device comprising:
a light emitting array including a plurality of light sources, and providing a backlight source;
a conical light cup array including a plurality of conical light cups, and set on an incoming light side of the conical light cup array, wherein each of the light sources corresponds to a corresponding one of the conical light cups, and the conical light cup array is configured to magnify the backlight source to reduce diffusion angle of the backlight source;
a diffuser set on an outgoing light side of the conical light cup array, and configured to increase uniformity of the backlight source;
a first curved mirror for receiving and reflecting the backlight source;
a second curved mirror for receiving and reflecting the backlight source reflected by the first curved mirror;
a display module for receiving the backlight source reflected by the second curved mirror; and
at least one of the first curved mirror and the second curved mirror is a concave mirror, which is used for magnifying and pulling away the backlight source.

2. The off-axis dual mirror focusing backlight display device as claimed in claim 1, wherein the conical light cups are hollow light cups coated with a high reflectivity coating or transparent solid light cups.

3. The off-axis dual mirror focusing backlight display device as claimed in claim 1, wherein one of the first and second curved mirrors is a concave mirror, and the other is a concave or convex mirror.

4. The off-axis dual mirror focusing backlight display device as claimed in claim 1, wherein the conical light cups of the conical light cup array have different inclinations.

5. The off-axis dual mirror focusing backlight display device as claimed in claim 1, wherein the diffuser is a curved sheet member or a planar sheet member.

6. The off-axis dual mirror focusing backlight display device as claimed in claim 1 further comprising a convex lens array, the diffuser is a planar sheet member, the convex lens array includes a plurality of convex lenses, the convex lens array is arranged on an outgoing light side of the diffuser, so that the diffuser is located between the convex lens array and the conical light cup array.

7. A head-up display device with the off-axis dual mirror focusing backlight display device as claimed in claim 1 further comprising a windshield for reflecting an image light source projected from the display module.

8. A head-up display device with the off-axis dual mirror focusing backlight display device as claimed in claim 4 further comprising a windshield for reflecting an image light source projected from the display module.

9. A head-up display device with the off-axis dual mirror focusing backlight display device as claimed in claim 6 further comprising a windshield for reflecting an image light source projected from the display module.

10. The head-up display device as claimed in claim 7, wherein the image light source projected from the display module and reflected by the windshield is a virtual image, the backlight source is imaged in real image by passing through the first curved mirror and the second curved mirror, and is imaged at a driver's eye box position through reflection of the windshield.

11. The head-up display device as claimed in claim 8, wherein the image light source projected from the display module and reflected by the windshield is a virtual image, the backlight source is imaged in real image by passing through the first curved mirror and the second curved mirror, and is imaged at a driver's eye box position through reflection of the windshield.

12. The head-up display device as claimed in claim 9, wherein the image light source projected from the display module and reflected by the windshield is a virtual image, the backlight source is imaged in real image by passing through the first curved mirror and the second curved mirror, and is imaged at a driver's eye box position through reflection of the windshield.

13. A head-up display device with the off-axis dual mirror focusing backlight display device as claimed in claim 1 further comprising a windshield and an imaging concave mirror, the imaging concave mirror is configured to reflect an image light source projected by the display module to the windshield, and the windshield is configured to reflect the image light source and image at a driver's eye box position.

14. A head-up display device with the off-axis dual mirror focusing backlight display device as claimed in claim 4 further comprising a windshield and an imaging concave mirror, the imaging concave mirror is configured to reflect an image light source projected by the display module to the windshield, and the windshield is configured to reflect the image light source and image at a driver's eye box position.

15. A head-up display device with the off-axis dual mirror focusing backlight display device as claimed in claim 5 further comprising a windshield and an imaging concave mirror, the imaging concave mirror is configured to reflect an image light source projected by the display module to the windshield, and the windshield is configured to reflect the image light source and image at a driver's eye box position.

16. A head-up display device with the off-axis dual mirror focusing backlight display device as claimed in claim 6 further comprising a windshield and an imaging concave mirror, the imaging concave mirror is configured to reflect an image light source projected by the display module to the windshield, and the windshield is configured to reflect the image light source and image at a driver's eye box position.

17. The head-up display device as claimed in claim 13, wherein the display module is set within the focal length of the imaging concave mirror, the equivalent distance of the backlight source is greater than the focal length of the imaging concave mirror, a virtual image formed by the display module is located outside the windshield, and the backlight source forms the driver's eye box position inside the windshield.

18. The head-up display device as claimed in claim 14, wherein the display module is set within the focal length of the imaging concave mirror, the equivalent distance of the backlight source is greater than the focal length of the imaging concave mirror, a virtual image formed by the display module is located outside the windshield, and the backlight source forms the driver's eye box position inside the windshield.

19. The head-up display device as claimed in claim 15, wherein the display module is set within the focal length of the imaging concave mirror, the equivalent distance of the backlight source is greater than the focal length of the imaging concave mirror, a virtual image formed by the display module is located outside the windshield, and the backlight source forms the driver's eye box position inside the windshield.

20. The head-up display device as claimed in claim 16, wherein the display module is set within the focal length of the imaging concave mirror, the equivalent distance of the backlight source is greater than the focal length of the imaging concave mirror, a virtual image formed by the display module is located outside the windshield, and the backlight source forms the driver's eye box position inside the windshield.
